(19) United States
(12) Patent Application Publication
(10) Pub. No.: US 2025/0022281 A1
(43) Pub. Date: Jan. 16, 2025

(54) METHOD AND APPARATUS FOR IMPROVING THE PERFORMANCE OF A VEHICLE IMAGE RECOGNITION SYSTEM

(71) Applicant: Bayerische Motoren Werke Aktiengesellschaft, Muenchen (DE)

(72) Inventors: Johannes Feldmaier, Ebersberg (DE); Vincent Karas, Muenchen (DE)

(21) Appl. No.: 18/712,139

(22) PCT Filed: Sep. 28, 2022
(86) PCT No.: PCT/EP2022/076906

§ 371 Date: May 21, 2024

(30) Foreign Application Priority Data
Dec. 7, 2021 (DE) 10 2021 132 102.6

(51) Int. Cl. G06V 20/56; H04N 23/60; H04N 23/84

(52) U.S. Cl. CPC G06V 20/56; H04N 23/64; H04N 23/84

(57) ABSTRACT

A method and system for improving the performance of an image recognition system in a vehicle is disclosed herein. The method includes obtaining information about a use of a data carrier by a user, and activating an RGB function of the image recognition system. The method further includes determining information presented on the data carrier, and evaluating the determined information. The determination of the information and/or the evaluation of the determined information is carried out by means of the activated RGB function of the image recognition system. Additionally, the method includes taking a measure on the basis of the evaluated information.

### CROSS-REFERENCE TO RELATED APPLICATIONS

The present application is the U.S. national phase of PCT Application PCT/EP2022/076906 filed on Sep. 28, 2022, which claims priority of German patent application No. 10 2021 132 102.6 filed on Dec. 7, 2021, the entire contents of which are incorporated herein by reference.

### FIELD

The present disclosure relates to image recognition systems in vehicles and to a method, a computer program, and apparatus for improving the performance of an image recognition system in a vehicle.

### BACKGROUND

Existing camera systems use either infrared or RGB camera systems to detect individuals or objects, e.g. data carriers, for example in a vehicle. Certain objects or image content may in this case sometimes be able to be detected only using the infrared camera system or using the RGB camera system. For example, the infrared camera system in the vehicle is used in order to detect individuals and objects in the vehicle interior even when the lighting is poor, e.g. at night. Detection of a screen content, e.g. of a smartphone, by means of the infrared camera system is not possible, on the other hand. This can be accomplished using the RGB camera system, for example. A disadvantage of this is that the RGB camera system (for example an RGB function for determining the screen content) is constantly in operation, e.g. an algorithm needs to run that looks for QR codes or text elements in the image and analyzes them upon detection, which may require RGB images. This results in an increased energy requirement and/or an increased processing power, which can adversely affect the performance of an image recognition system.

There is therefore a need to provide a concept for improving the performance of an image recognition system.

### SUMMARY

Exemplary embodiments are based on the key concept that the performance of an image recognition system can be improved by activating an RGB function of an image recognition system. The activation in this case is dependent on the obtainment of information about a use of a data carrier by a user. For example, a user can hold a smartphone in one hand and open an application on the smartphone, e.g. an e-mail program, in particular a calendar containing appointment data. The smartphone can then transmit information about a use to the image recognition system, e.g. by means of a Bluetooth connection, wireless area network connection, etc. The image recognition system can then activate an RGB function, e.g. an RGB camera of the image recognition system, and read the information on the display of the smartphone, for example an address from a calendar. This information can then be taken as a basis for taking a measure, e.g. navigation software can be started, for example by sending a message from the image recognition system to a control unit (ECU) of the vehicle, which then opens navigation software on a display of the vehicle. The targeted activation of the RGB function allows an energy consumption and/or a required processing power of the image recognition system to be reduced.

Exemplary embodiments relate to a method for improving the performance of an image recognition system. The method comprises obtaining information about a use of a data carrier by a user and activating an RGB function of the image recognition system. Further, the method comprises determining information presented on the data carrier and evaluating the determined information. The determination of the information and/or the evaluation of the determined information is carried out by means of the activated RGB function of the image recognition system. Further, the method comprises taking a measure on the basis of the evaluated information. This permits the RGB function of the image recognition system to be used only when it is needed, thus reducing energy consumption.

In some exemplary embodiments, the obtainment of the information about a use may comprise determination by means of an infrared camera. This allows information about the use to be advantageously determined, since an infrared camera can also be used for other functions in a vehicle, e.g. for monitoring a driver, and therefore may be switched on as standard.

In some exemplary embodiments, the obtainment of the information about a use may comprise determination of a position of the data carrier relative to the image recognition system. This allows determination of a use of the data carrier by a user to be improved. For example, the data carrier can be held by the user in a position that is well suited to determining the information of the data carrier (for example the user knows this from previous applications), and so the position of the data carrier can be taken as a basis for assuming that the user wishes to see the information of the data carrier. Accordingly, the position determination relating to the data carrier can improve the activation of the RGB function.

In some exemplary embodiments, the image recognition system may comprise a plurality of RGB cameras. Further, the activation of the RGB function of the image recognition system can result in an RGB camera of the image recognition system being activated and the method may further comprise determining an RGB camera that is to be activated in the image recognition system on the basis of the determined position of the data carrier. This allows an RGB camera that determines improved ascertainment of the information to be activated.

In some exemplary embodiments, the data carrier may be an electronic apparatus. Further, the obtainment of the information a about use may comprise reception of information about a status of the electronic apparatus. This allows the electronic apparatus to directly notify the image recognition system of a use, thus allowing a use to be determined particularly advantageously.

In some exemplary embodiments, the obtainment of the information about a use may comprise determination of an alignment of the data carrier relative to the image recognition system. This allows for example detection of a use by a user with the intention of reading information of the data carrier by way of the image recognition system to be improved. For example, the user can show the data carrier to another person in a vehicle, and so an alignment of the data carrier may not be suitable for reading the information by means of the image recognition system. The determination of the alignment can e.g. prevent unnecessary activation of the RGB function in such a case.

In some exemplary embodiments, the taking of a measure may comprise output of information about a required position and/or for alignment of the data carrier improved determination of the information of the data carrier. This allows the user to be provided with feedback about a position of the data carrier, allowing them to hold the data carrier in a position in which the information of the data carrier can be better captured, for example.

Some exemplary embodiments may further comprise deactivating the RGB function of the image recognition system after the information presented on the data carrier has been determined. This allows the energy consumption or the required processing power to be reduced further after the information of the data carrier has been captured.

Exemplary embodiments also provide a computer program for carrying out one of the methods described herein when the computer program runs on a computer, a processor or a programmable hardware component.

Another exemplary embodiment is an apparatus for an image recognition system for improving the performance of the image recognition system. The apparatus comprises one or more interfaces for communication with other communication devices (e.g. the data carrier, an ECU of a vehicle, etc.) and a control module designed to carry out at least one of the methods described herein. Exemplary embodiments furthermore provide a vehicle having an image recognition system as described herein.

### BRIEF DESCRIPTION OF THE DRAWINGS

Exemplary embodiments are explained in more detail hereinbelow with reference to the accompanying figures, in which:

FIG. 1 shows a schematic representation of a method for improving the performance of an image recognition system;

FIG. 2 shows a block diagram of an exemplary embodiment of an apparatus for an image recognition system; and

FIG. 3 shows a schematic representation of a vehicle that comprises an image recognition system having an apparatus as shown in FIG. 2 for improving the performance of the image recognition system.

Various exemplary embodiments are now described more thoroughly with reference to the accompanying drawings, which depict some exemplary embodiments. In the figures, the thickness dimensions of lines, layers and/or regions may be depicted in an exaggerated manner for the sake of clarity.

### DESCRIPTION

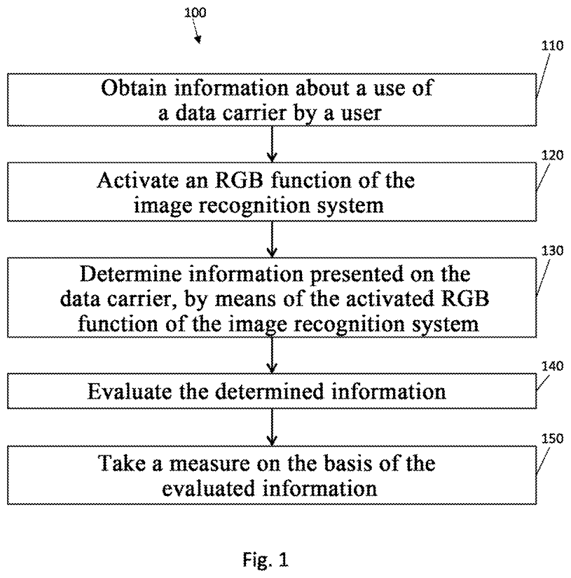

FIG. 1 shows a schematic representation of a method 100 for improving the performance of an image recognition system. The method 100 comprises obtaining 110 information about a use of a data carrier by a user and activating 120 an RGB function of the image recognition system (on the basis of the obtained information). In addition, the method 100 comprises determining 130 information presented on the data carrier and evaluating 140 the determined information. The determination of the information and/or the evaluation of the determined information is carried out by means of the activated RGB function of the image recognition system. Further, the method 100 comprises taking 150 a measure on the basis of the evaluated information.

The data carrier may be an analog data carrier, e.g. a book, a visiting card, a concert ticket, etc., or a digital data carrier, in particular a digital data carrier having a display, e.g. a user terminal, a tablet, etc. The data carrier can be understood to mean in particular any object that is suitable for presenting information, or contains a presentation of information, e.g. a sheet of paper containing writing/printing, a display device such as a display of a user terminal, etc.

Obtaining 110 the information about the use of the data carrier may comprise determining the information or receiving the information. For example, the data carrier may be a user terminal that sends a signal about a use to the image recognition system. This signal can be sent for example by means of Bluetooth, wireless local area network, Universal Mobile Telecommunications System, 3GPP Long Term Evolution, etc., and received by the image recognition system. The image recognition system may have for example an interface that is designed to receive signals from a user terminal. This allows the image recognition system to be advantageously informed about a use of the data carrier.

Optionally or alternatively, the image recognition system can also receive signals from a different electronic apparatus, e.g. an ECU of a vehicle. For example, the user terminal can send information about a use to the ECU of the vehicle, which forwards the information to the image recognition system. For example, the image recognition system can obtain information from a charging cradle for a smartphone via the ECU, and, if the smartphone is removed from the charging cradle, this can indicate a use and the ECU can send information to the image recognition system about a use.

The information about a use can be determined for example by means of a sensor of the image recognition system, e.g. by means of an infrared camera, an RGB camera, a sound transducer, etc. For example, the data carrier can produce a sound during use that is picked up by a sound transducer of the image recognition system. The data carrier may be a smartphone that e.g. can be called/receives a message and, as a result of the call/message, transmits a sound, e.g. a ringtone, a vibration, etc., that can be picked up by the sound transducer of the image recognition system. A use of the data carrier may thus in particular also be a probable future “active” use by the user, e.g. because they accept a call. Accordingly, the RGB function could already be activated 120 when a sound produced by the data carrier is received/determined by the image recognition system (e.g. the sound transducer). A use may also exist when the user wishes to use/activates the data carrier, e.g. a user terminal, by way of a voice input. This voice input can be picked up/processed by the sound transducer of the image recognition system and can indicate a use of the user terminal.

By way of example, the data carrier may be a piece of paper, e.g. a concert ticket, visiting card, etc., that, as a result of being used by a user (e.g. being removed from pocket), a that can a produces sound be received/determined by the image recognition system (the sound transducer). Alternatively, information about a received signal can also be sent from the ECU of a vehicle to the image recognition system.

For example, a use of a data carrier can be ascertained via a correlation with an action by the user. A use may exist in particular when the user is holding the data carrier in their hand. An infrared camera can be used by the image recognition system to determine that a user is holding a data carrier, e.g. a user terminal, a visiting card, etc., in their hand, for example. This may then be a use of the data carrier, because the user is holding it in their hand.

Activating 120 an RGB function may comprise e.g. activating 120 an RGB camera (specifically an RGB path), an algorithm for QR code recognition, an algorithm for Global Positioning System data recognition, an algorithm for text recognition, etc. In particular, corresponding algorithms need RGB images/videos for recognition, which is why they are also referred to as an RGB function. For example, a control apparatus of an RGB camera can be activated, which permits an RGB image/video to be recorded by the image recognition system by means of an RGB camera. While the control unit or algorithms for evaluating RGB images/videos are deactivated, an energy consumption of the image recognition system can be advantageously reduced. Optionally, the activation of the RGB camera can then also result in a corresponding algorithm for recognition being activated. Alternatively, an RGB camera can be constantly activated and an algorithm can be activated when the data carrier is used by the user. While the algorithm is deactivated, an energy consumption and/or computing resources of the image recognition system can also be advantageously reduced.

Determining 130 the information can comprise for example capturing RGB images by means of an RGB camera. For example, an RGB path of a camera may have been activated 120 as the RGB function of the image recognition system. RGB images generally means images that lie in the spectral range visible to the human eye. In particular, sensors for capturing RGB images are suitable for ensuring sufficient accuracy of a presentation of the information of the data carrier to allow said information to be evaluated using algorithms known from other systems. For example, an infrared camera cannot be used to permit sufficient accuracy of the information of the data carrier. An RGB camera, that is to say in particular using sensors that operate in the visible range, can be used to improve determination 130 of the information, and so evaluation 140 of the information is permitted.

Evaluating 140 the determined information can comprise recognizing/evaluating a QR code, GPS coordinates, a visiting card, etc. For example, a corresponding algorithm may have been activated 120 as the RGB function of the image recognition system.

Taking 150 a measure can comprise sending information to the data carrier (e.g. a smartphone), outputting an audible signal, sending information to an ECU of a vehicle, etc. For example, a QR code can be read and information stored in the QR code can be sent to the data carrier/ECU of a vehicle by the ECU for presentation on the data carrier (e.g. a display of a user terminal) or on a display of a vehicle. The measure can improve in particular a user experience when using the data carrier.

In one exemplary embodiment, the obtainment 110 of the information about a use can comprise determination by means of an infrared camera. The infrared camera may be included in the image recognition system. For example, the image recognition system may comprise two paths, an infrared path and an RGB path. Software of the image recognition system can implement object detection for the data carrier. The implementation of the object detection can serve to increase safety for a user. For example, a user can be distracted by the data carrier, which can result in concentration on other tasks being reduced, e.g. a user can be distracted from steering a vehicle.

The object detection can take place in particular in the infrared range. The infrared range is suitable for monitoring a user, e.g. within the context of driver assistance systems, which is why it may be constantly switched on. Further, an energy consumption of an infrared camera can be reduced in comparison with an RGB camera. This allows use of a data carrier to be determined by means of the infrared camera with lower energy consumption.

Provided that the infrared path has been used to determine a use of a data carrier, the RGB path of the image recognition system can be activated 120 in order to determine 130 information on the data carrier. Further, an algorithm for evaluating 140 the determined information can be activated 120.

For example, the infrared path can be used to determine 110 the information that a data carrier is in the hand of a user. This information can be interpreted as use of the data carrier, and the RGB path of the image recognition system can be activated 120. In the RGB path of the image recognition system there may then be the possibility of determining 130 the information of the data carrier, e.g. an activity by a display of a smartphone. An active display can then result in further images being recorded in the RGB range (or an RGB video being recorded). The RGB images/RGB video thus recorded can then be evaluated by means of an algorithm, for example a QR code algorithm, OCR algorithm, etc.

Accordingly, the RGB functions, RGB path and algorithm recognition are activated 120 only when there is a possibility of the user wishing to scan a code/text, for which purpose a use of the data carrier by the user is essential. Should the display of a user terminal be inactive, for example, the RGB functions are not activated and no unnecessary analysis is attempted.

In one exemplary embodiment, the obtainment 110 of the information about a use may comprise determination of a position of the data carrier relative to the image recognition system. For example, a user can hold the data carrier in a particularly suitable position for determining 130 information of the data carrier. This position may be known to the user, e.g. as a result of previous uses. The position of the data carrier can be determined for example by means of an infrared camera of the image recognition system, by means of triangulation of radio signals (e.g. on the basis of exchanged Bluetooth signals between the image recognition system and the user terminal), etc. This allows determination 110 of a use of the data carrier to be improved.

In one exemplary embodiment, the image recognition system may comprise a plurality of RGB cameras. The activation 120 of the RGB function of the image recognition system can result in an RGB camera of the image recognition system being activated. Further, the method 100 may comprise determining RGB camera that is to be activated in the image recognition system on the basis of the determined position of the data carrier. This allows a particularly suitable RGB camera to be selected for determining 130 the information of the data carrier. For example, any RGB camera from the plurality of RGB cameras can have a specific coverage area. Accordingly, a specific RGB camera can be activated 120 according to a position of the data carrier.

In one exemplary embodiment, the data carrier may be an electronic apparatus and the obtainment of the information about a use may comprise reception of information about a status of the electronic apparatus. In particular, the electronic apparatus may be connected to the image recognition system by means of a wireless connection. To this end, the image recognition system may have an antenna apparatus. This allows the electronic apparatus to actively inform the image recognition system about a use of the electronic apparatus, for example about the use of an application.

In one exemplary embodiment, the obtainment of the information about a use may comprise determination of an alignment of the data carrier relative to the image recognition system. For example, a user may hold a data carrier in one hand in order to show it to another person (e.g. a front seat passenger). Accordingly, the alignment of the data carrier can be taken as a basis for more accurately determining a use by the user that is supposed to result in activation of an RGB function. In particular, a touch of a data carrier by the user may not be a use, for example if the user is passing the data carrier to another person, showing the data carrier to another person, etc. Accordingly, the determination of an alignment can allow a use of the data carrier to be determined more accurately, with the result that erroneous activations of the RGB function can be reduced. In particular, not every interaction by the user with the data carrier may thus be a use (depending on the alignment of the data carrier).

In one exemplary embodiment, the taking of a measure may comprise output of information about a required position and/or alignment of the data carrier for improved determination of the information of the data carrier. For example, the data carrier may be a user terminal and obtain information relating to the position/alignment of the user terminal from the image recognition system. For example, this information can be presented on a display of the user terminal, making it easier for a user to position/align the user terminal. Optionally or alternatively, this information may also be presented on a different display, for example a display of a vehicle. For example, a visual representation of the camera field of view, in particular with highlighting of a region in which the data carrier is supposed to be positioned in order to recognize the content of the data carrier, can be presented on the display of the vehicle. The display of the vehicle may be for example a head-up display, a dashboard display, etc. For example, audible feedback about a position/alignment of the data carrier can also be provided by the image recognition system or the ECU of a vehicle, for example in the form of bleeps for when a required position/alignment of the data carrier is being approached. This allows a user to position/align the data carrier without having to look at the data carrier.

In one exemplary embodiment, the method 100 may further comprise deactivating the RGB function of the image recognition system after the information presented on the data carrier has been determined. For example, a control unit of an RGB camera, an algorithm for QR code recognition, etc., of the image recognition system can be deactivated. This allows an energy consumption of the image recognition system to be reduced after the measure to enhance a user experience has been taken.

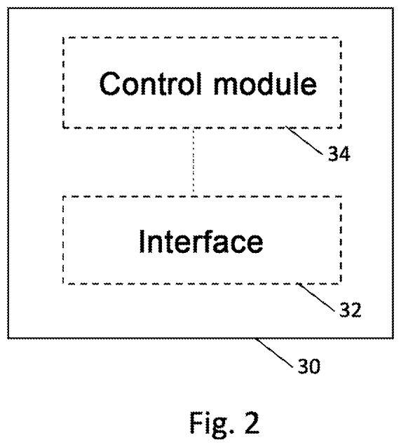

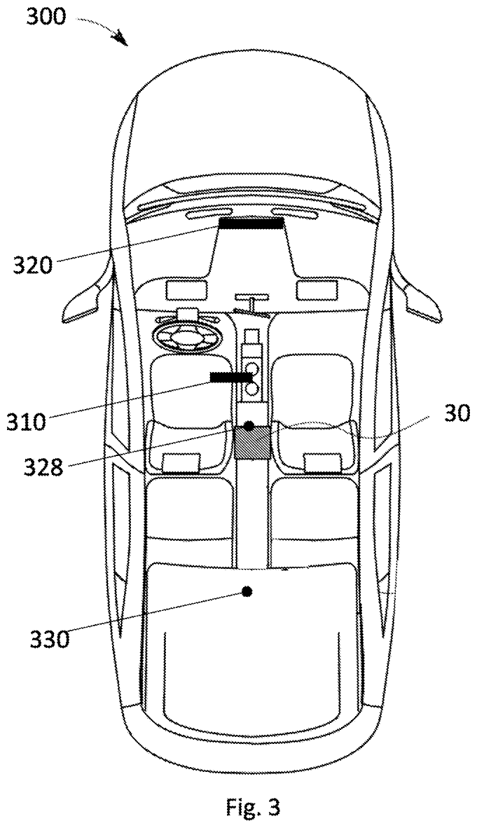

Further details and aspects are mentioned in connection with the exemplary embodiments described below. The exemplary embodiment shown in FIG. 1 may comprise one or more optional additional features that are consistent with one or more aspects mentioned in connection with the proposed concept or with one or more exemplary embodiments described below (e.g. FIGS. 2-3).

FIG. 2 shows a block diagram of an exemplary embodiment of an apparatus 30 for an image recognition system. The apparatus 30 for improving the performance of an image recognition system comprises one or more interfaces 32 for communication with other components of the image recognition system, e.g. an RGB camera. The apparatus 30 further comprises a control module 34 designed to carry out at least one of the methods described herein, for example the method described with reference to FIG. 1. Other exemplary embodiments are a vehicle having an image recognition system having an apparatus 30.

The one or more interfaces 32 may be consistent for example with one or more inputs and/or one or more outputs for receiving and/or transmitting information, for instance in digital bit values, based on a code, within a module, between modules, or between modules of different entities. The at least one interface 32 may be designed for example to communicate with other network components via a (radio) network or a local connection network.

In exemplary embodiments, the control module 34 may be consistent with any controller or processor or a programmable hardware component. For example, the control module 34 may also be realized as software that is programmed for an applicable hardware component. In this respect, the control module 34 may be implemented as programmable hardware having appropriately adapted software. Any processors, such as digital signal processors (DSPs), can be used here. Exemplary embodiments are not restricted to one specific type of processor. Any processors or multiple processors are conceivable for implementing the control module 34. Controllers are commonly used in vehicles in association with vehicle operation. Controllers (which may also be referred to herein as “control units,” “control modules,” “processors” or “microprocessors”) include circuits (e.g., integrated circuits) that contain typical functionality of central processing units (CPUs) and are configured to perform various calculations and analysis based on manufacturer programming and/or circuit components. Examples of controllers used in vehicles include any of various Engine Control Units (ECUs) and other controllers that are commonly used by different manufacturers in modern automobiles.

In at least some exemplary embodiments, the vehicle may be consistent for example with a land vehicle, a water vehicle, an aircraft, a rail vehicle, a road vehicle, a car, a bus, a motorcycle, an all-terrain vehicle, a motor vehicle or a truck.

Further details and aspects are mentioned in connection with the exemplary embodiments described below and/or above. The exemplary embodiment shown in FIG. 2 may comprise one or more optional additional features consistent with one or more aspects mentioned in connection with the proposed concept or one or more exemplary embodiments described above (e.g. FIG. 1) and/or below (e.g. FIG. 3).

FIG. 3 shows a schematic representation of a vehicle 300 that comprises an apparatus 30 (e.g. the apparatus 30 described with reference to FIG. 2) of an image recognition system for improving the performance of the image recognition system. The image recognition system may comprise in particular an interior camera system (IKS) having an infrared camera, an IR-LED and an RGB camera. All of these components may be designed to observe an interior of the vehicle 300.

An IR path of the IR camera may be active as standard. From their position, the IR camera and the RGB camera can detect the driver, front seat passenger, passengers in the rear seats and items in the vehicle. Optionally, a plurality of IR cameras and/or RGB cameras can be used. By way of example, a first RGB camera 328 of the image recognition can system capture the front region containing the driver and the front seat passenger and a second RGB camera 330 of the image recognition system can capture a rear region of the vehicle for other passengers.

The IR path of the IR camera may be active as standard because in general it can be used for monitoring the driver. It is in particular resistant to illumination changes, and so reliable detection of a data carrier or of a use thereof can be practised. A control unit, e.g. the control module of the apparatus 30, processes the data stream from the IR camera to produce frames and is able to make these available to different functions. These include safety-related functions and comfort functions.

By way of example, a mobile phone detection system can be used. The mobile phone detection system retrieves frames from the IR camera and examines them for whether a smartphone 310 is in the interior or a user is holding the smartphone 310 in their hand. If the mobile phone detection system detects that a smartphone 310 is being used, this information can be used to activate an RGB function. The mobile phone detection system can in particular also determine a position and/or an alignment of the smartphone 310 in the interior of the vehicle 30, allowing determination of a use of the smartphone 310 to be improved.

For example, the mobile phone detection system could determine (for example on the basis of the information from the IR camera) that the smartphone 310 is being held in the direction of the first RGB camera 328 of the image recognition system. The RGB camera of the image recognition system can then be activated so that information presented on a display of the smartphone 310 can be captured. Optionally or alternatively, a QR code/text recognition algorithm can be started. For example, the algorithm can request RGB images, resulting first in an RGB path of the IKS being activated. RGB frames can then be produced and forwarded to the QR/text recognition, which analyses the images for the presence of QR codes/text/addresses on the smartphone display.

If a code/text is found, the decryption and processing of the data is executed by means of a customary algorithm as is known from other systems. The information obtained can then be analyzed and used by the apparatus 30, e.g. as access code, in order to make information available to the smartphone 310, in order to transmit information to a display 320 of the vehicle 300, etc.

For example, the apparatus 30 can recognize the intention of a user to move the smartphone 310 into a region that is optimally detected by the first RGB camera 328. To this end, the activation of the RGB path could result in information of an RGB photograph from the first RGB camera 328 being sent to the smartphone 310. This information can then be presented on the display of the smartphone 310 and visually represent for the user a region into which the smartphone 310 is intended to be moved for determining the information, e.g. for QR scanning/text recognition.

For example, the recognition (based on the RGB functions) can also be used to activate a different procedure, e.g. audio recognition, in order to receive audio signals of the smartphone 310 (or even radio signals, e.g. Bluetooth). A use of the smartphone 310 could be received by the apparatus, e.g. an application for playing back music could be opened on the smartphone 310, which the smartphone can use to send information to the apparatus 30. The RGB path of the first camera 328 can then be activated in order to read information on the display of the smartphone 310.

For example, the recognition can be used to determine information about a destination of a user. The user can hold a visiting card with an address or a concert ticket up to the camera. The information can then be determined by the apparatus 30. In particular, the measure based on the evaluated information may then be that the apparatus sends information about a specific destination of the user to an ECU of the vehicle 300. The vehicle 300 can then start a navigation program, for example, and make route information available to the user on a display 320. This can permit particularly simple route planning for the user.

For example, the recognition can be used to warn the user. The apparatus can ascertain that a user is currently using a smartphone 310, e.g. for streaming. The apparatus could then output an audible warning or send information to the ECU of the vehicle 300, as a result of which the vehicle 300, e.g. a driver assistance system, can output warning or the driver assistance systems can be adjusted.

Further details and aspects are mentioned in connection with the exemplary embodiments described above. The exemplary embodiment shown in FIG. 3 may comprise one or more optional additional features consistent with one or more aspects mentioned in connection with the proposed concept or one or more exemplary embodiments described above (e.g. FIGS. 1-2).

Other exemplary embodiments are computer programs for carrying out one of the methods described herein when the computer program runs on a computer, a processor or a programmable hardware component. Depending on determined implementation functionality, exemplary embodiments of the disclosure herein may be implemented in hardware or in software. The implementation can be carried out using a digital storage medium, for example a floppy disk, a DVD, a Blu-Ray disk, a CD, a ROM, a PROM, an EPROM, an EEPROM or a flash memory, a hard disk or another magnetic or optical memory storing electronically readable control signals that can interact or do interact with a programmable hardware component such that the respective method is carried out.

A programmable hardware component may be formed by a processor, a computer processor (CPU=Central Processing Unit), a graphics processor (GPU=Graphics Processing Unit), a computer, a computer system, an application-specific integrated circuit (ASIC), an integrated circuit (IC), a system on chip (SOC), a programmable logic element or a field programmable gate array (FPGA) with a microprocessor.

The digital storage medium may therefore be machine- or computer-readable. Some exemplary embodiments thus comprise a data carrier that has electronically readable control signals capable of interacting with a programmable computer system or a programmable hardware component such that one of the methods described herein is carried out. One exemplary embodiment is therefore a data carrier (or a digital storage medium or a computer-readable medium) on which the program for carrying out one of the methods described herein is recorded.

In general, exemplary embodiments of the present disclosure may be implemented as a program, firmware, a computer program or computer program product with a program code or as data, the program code or the data being effective to the extent of carrying out one of the methods when the program runs on a processor or a programmable hardware component. The program code or the data may for example also be stored on a machine-readable carrier or data carrier. The program code or the data may be present, inter alia, as source code, machine code or byte code and as some other intermediate code.

The exemplary embodiments described above are merely an illustration of the principles of the present disclosure. It goes without saying that modifications and variations of the arrangements and details described herein will become apparent to others skilled in the art. Therefore, the intention is that the disclosure shall be restricted only by the scope of protection of the patent claims that follow and not by the specific details that have been presented on the basis of the description and the explanation of the exemplary embodiments herein.

### LIST OF REFERENCE SIGNS

30 apparatus for improving the performance of an image recognition system
32 interface
34 control module
100 method
110 obtain information
120 activate an RGB function
130 determine information
140 evaluate the determined information
150 take a measure
300 vehicle
310 data carrier
320 display
328 first RGB camera
330 second RGB camera

1-10. (canceled)

11. A method for improving the performance of an image recognition system, the method comprising:
obtaining information about a use of a data carrier by a user;
activating an RGB function of the image recognition system;
determining information presented on the data carrier;
evaluating the determined information, the determination of the information and/or the evaluation of the determined information being carried out by means of the activated RGB function of the image recognition system; and
taking a measure on the basis of the evaluated information.

12. The method as claimed in claim 11, wherein the obtainment of the information about a use comprises determination by means of an infrared camera.

13. The method as claimed in claim 12, wherein the obtainment of the information about a use comprises determination of a position of the data carrier relative to the image recognition system.

14. The method as claimed in claim 13, wherein the image recognition system comprises a plurality of RGB cameras and wherein the activation of the RGB function of the image recognition system results in an RGB camera of the image recognition system being activated, the method further comprising:
determining an RGB camera that is to be activated in the image recognition system on the basis of the determined position of the data carrier.

15. The method as claimed in claim 14, wherein the obtainment of the information about a use comprises determination of an alignment of the data carrier relative to the image recognition system.

16. The method as claimed in claim 15, wherein the taking of a measure comprises output of information about a required position and/or alignment of the data carrier for improved determination of the information of the data carrier.

17. The method as claimed in claim 16, further comprising:
deactivating the RGB function of the image recognition system after the information presented on the data carrier has been determined.

18. A non-transitory computer-readable medium configured to improve the performance of an image recognition system, wherein the computer-readable medium comprises instructions which, when executed on a controller cause the controller to:
obtain information about a use of a data carrier by a user;
activate an RGB function of the image recognition system;
determine information presented on the data carrier;
evaluate the determined information, the determination of the information and/or the evaluation of the determined information being carried out by means of the activated RGB function of the image recognition system; and
take a measure on the basis of the evaluated information.

19. The non-transitory computer-readable medium of claim 18, wherein the obtaining of the information about a use comprises determining the use by means of an infrared camera.

20. The non-transitory computer-readable medium of claim 18, wherein the obtaining of the information about a use comprises determining a position of the data carrier relative to the image recognition system.

21. The non-transitory computer-readable medium of claim 20, wherein the image recognition system comprises a plurality of RGB cameras and wherein the activation of the RGB function of the image recognition system results in an RGB camera of the image recognition system being activated, the computer-readable medium further comprising instructions which, when executed on a controller cause the controller to:
determine an RGB camera that is to be activated in the image recognition system on the basis of the determined position of the data carrier.

22. The non-transitory computer-readable medium of claim 18, wherein the obtaining of the information about a use comprises determination of an alignment of the data carrier relative to the image recognition system.

23. The non-transitory computer-readable medium of claim 18, wherein the taking of a measure comprises output of information about a required position and/or alignment of the data carrier for improved determination of the information of the data carrier.

24. The non-transitory computer-readable medium of claim 18, the computer-readable medium further comprising instructions which, when executed on a controller cause the controller to:
deactivate the RGB function of the image recognition system after the information presented on the data carrier has been determined.

25. A vehicle including an apparatus for improving the performance of an image recognition system, the vehicle comprising:
one or more interfaces for communication with other communication devices; and
a controller configured to:
obtain information about a use of a data carrier by a user;
activate an RGB function of the image recognition system;
determine information presented on the data carrier;
evaluate the determined information, the determination of the information and/or the evaluation of the determined information being carried out by means of the activated RGB function of the image recognition system; and
take a measure on the basis of the evaluated information.

26. The vehicle of claim 25, wherein the obtaining of the information about a use comprises determining the use by means of an infrared camera.

27. The vehicle of claim 25, wherein:
the obtaining of the information about a use comprises determining a position of the data carrier relative to the image recognition system,
the image recognition system comprises a plurality of RGB cameras and wherein the activation of the RGB function of the image recognition system results in an RGB camera of the image recognition system being activated,
and the controller is further configured to determine an RGB camera that is to be activated in the image recognition system on the basis of the determined position of the data carrier.
